(19) United States
(12) Patent Application Publication
(10) Pub. No.: US 2020/0214327 A1
(43) Pub. Date: Jul. 9, 2020

(54) Method For Producing A Food, In Particular A Snack Product, With Improved Introduction Of An Additive By Application Of An Electric Field

(71) Applicant: ELEA VERTRIEBS-UND VERMARKTUNGSGESELLSCHAFT MBH, Quakenbruck (DE)

(72) Inventors: Robin OSTERMEIER, Osnabruck (DE); Isabell BEYER, Hannover (DE); Stefan TOEPFL, Osnabruck (DE)

(21) Appl. No.: 16/615,561

(22) PCT Filed: Jun. 12, 2018
(86) PCT No.: PCT/EP2018/065442

§ 371 Date: Nov. 21, 2019

(30) Foreign Application Priority Data
Jun. 20, 2017 (DE) 10 2017 210 328.0

(51) Int. Cl. A23L 5/30; A23L 19/18; A23L 3/32; A23B 7/015

(52) U.S. Cl. CPC A23L 5/30; A23L 19/18; A23V 2002/00; A23B 7/015; A23L 3/32

(57) ABSTRACT

The present invention relates to the production of a food product, in particular a snack product. In order to distribute additives evenly in a food product, in particular in a snack product, and to obtain a more homogeneous product quality, the method according to the invention comprises the steps of:
conditioning the food product by applying an electric field;
introducing an additive into the food product; and
preserving the food product after the additive has been introduced.

The present invention relates to the production of a food product, in particular a snack product.

Snack products are preserved food products representing an in-between meal, i.e. a snack, and are often offered packaged as finger food ready for consumption. Examples of snack products are products to nibble, such as dried fruits, nut mixtures or salty snacks such as potato chips, peanut flips or crackers.

In the production of such snack products, it is common for additives such as flavors, salts, spices to be surface-applied at the end of the production process, after preservation.

However, surface application leads to an uneven distribution, since the additives do not enter into the core of the food product. This is not only detrimental to product quality, such as the taste sensation, but requires an increased surface dosage of the additive to compensate for the absence of the additive within the food produced.

The object of the present invention is therefore to produce of a food product, in particular a snack product, in which the additives are evenly distributed and which therefore exhibits more homogeneous product quality.

The present invention satisfies this object with a method for the production of a food product comprising the steps of:
conditioning the food product by applying an electric field;
introducing an additive into the food product; and
preserving the food product after the additive has been introduced.

The present invention has surprisingly shown that conditioning the food product by applying an electric field enters an additive uniformly into the food product, where the additive remains homogeneously distributed in the food product after the preservation of the food product. In comparison to pure surface application, for example, of a spice or an aromatic substance, the method of the invention therefore achieves a more uniform distribution of the additive and obtains a food product providing an equivalent taste sensation. In addition, it was surprisingly found that a more homogeneous product quality can be obtained even with a lower dosage of the additive than with surface application after preservation.

Food products are substantially macronutrient substances that are consumed to feed the human body. Macronutrients, i.e. carbohydrates, lipids/fats and proteins, provide humans with chemically bound energy.

An additive is a compound that is added to foods to achieve chemical, physical or physiological effects. Additives alone are not consumed as food.

Preservation is understood to be a process in the treatment of foods that makes them have a longer shelf life in that their spoiling is stopped or extremely slowed down, while at the same time preserving the nutritional value, the taste, color and texture of the food as much as possible.

The invention can be further improved by the following developments, which are advantageous each by itself and can be combined with one another as desired, and advantageous embodiments.

According to one embodiment, a pulsed electric field causing a cell disruption is applied during the conditioning. Therefore, electroporation takes place in which the semipermeability of the cell membrane is removed by applying an electric field, in particular a pulsed electric field.

Removing semipermeability facilitates the introduction of additives into the cells of the food and improves substance transport within the cell structures. The semipermeability of the cell membrane can be reversibly or irreversibly removed, whereby irreversible electroporation is preferred, because the permanent removal of semipermeability allows for more flexibility in the sequence of the individual process steps. But also reversible electroporation, which requires less energy than irreversible electroporation, can be practicable.

Energy of at least 0.5 kJ/kg, preferably of at least one kJ/kg can be input for conditioning. An energy input of this magnitude is well suited to perform irreversible electroporation and to effectively introduce additives into the food.

It has shown that it is advantageous to have an electric field of 0.5 kV/cm to 2 kV/cm be applied. Such field strengths can be obtained with commercially available industrial capacitors and prevent unwanted thermal effects during the conditioning of the food which would lead to unwanted alterations of the food.

The electric field, in particular, the electrical pulses, can be generated both by direct contact of the capacitor or its electrodes, respectively, with the food products, as well as by way of conductive fluids, where the food products are totally or in part inserted into the conductive fluids. Different electrode shapes can there be employed, for example plate, ring, grid, hollow or flow-through electrodes.

A high voltage pulse generator generating electric fields in the form of short pulses in the micro to millisecond range at a high voltage in the kilovolt range can preferably be used as the pulse generator. Marx generators can be used as high-voltage pulse generators.

In terms of time and energy optimization, the food product can be conditioned with at least 10 electrical pulses, preferably 10 to 200 electrical pulses, and more preferably 30 to 50 electrical pulses.

The electric field applied can be, in particular, a non-thermally acting electric field in which the upper energy limit is determined such that substantially no heating of the food products in the sense of ohmic heating takes place.

According to a further embodiment, the step of conditioning can take place before or during the step of introducing the additive. Simultaneously conditioning and introducing the additive reduces the number of processing steps for the food product and accelerates the production process. A successive sequence of the steps of conditioning and subsequently introducing the additive provides greater variability in terms of the additives to be introduced, which are, for example, incompatible with a fluid in which the electroporation is performed or which could be damaged when an electric field is applied.

According to one further embodiment, the method according to the invention can comprise the further step that mechanical energy acts upon the food product, preferably during or after the step of introducing the additive. Mechanical energy can act upon the food, for example, in that it is cut up, stirred, kneaded, beaten and/or tossed. The mechanical energy acting upon the food product improves diffusion and therefore the distribution of the additive in the structure of the food product. Mechanical energy can also increase the surface area and improve the transport of substances. In one embodiment, the step of mechanical energy acting upon the food product takes place prior to the step of preservation to ensure that a homogeneous distribution of the additive in the food product is obtained.

As already mentioned above, an additive is no food product that is consumed, but compounds added to the food for the purpose of obtaining chemical, physical or physiological effects. According to the invention, an additive can be, for example, an additive providing flavor, providing or preserving structure, providing coloring, providing aroma, regulating the utilization value, regulating the nutritional value, stabilizing the utilization value, stabilizing the nutritional value and/or an additive ensuring trouble-free further processing of the food product. Additives that regulate or stabilize the utilization or nutritional value include in particular additives that promote the chemical and microbial shelf life of processed foods. Additives which ensure trouble-free further processing of the food are, in particular, additives which maintain or improve the technological properties of the food product, such as the improvement of the ability to be baked, the ability to be spread, the ability to trickle or machine suitability. Examples of additives, especially in the production of snack products, are salts, flavors, extracts or spices.

According to one further embodiment, a precursor of the additive, which can be converted into the additive, can be introduced into the food product. The precursor, i.e. a precursor of the additive, can be converted into the additive, for example, during preservation.

According to one further embodiment, the additive can be brought into contact with the food product as a dry product, dissolved or as an emulsion and thus be introduced into the food product. For this purpose, the additive can be, for example, injected into the food product. It is also possible to insert the food product into the additive, to brush the food product with the additive, to spray it on or to dust the food product with the additive, depending on the type of additive and the form of application in which it is present

If the food product is placed into the additive and, for example, an additive dissolved in water is used, then this solution with the food product immersed could be exposed to the electric field and the steps of conditioning and introducing could be performed simultaneously in this manner.

According to one further embodiment, the method according to the invention comprises a further step: adjusting a desired oil content of the food product. The oil content can be adjusted, for example, prior to the preservation step. If a desired oil content of, for example, 10%, is set, then energy- and cost-intensive preservation by way of, for example, deep-frying can sometimes be dispensed with and instead a different, gentler or economically more sensible method of preservation in terms of resources can be employed.

According to one embodiment, the oil content can be adjusted during the introduction of the additive into the food. This can be achieved, for example, in that the additive is present as an oil solution, i.e. an additive dissolved in oil or emulsified, i.e. as an oil/water or water/oil emulsion. Since many flavors or spices are more oil- than water-soluble, the additional advantageous side effect of adjusting a desired oil content can be realized in a simple and advantageous manner with the method according to the invention.

According to one further embodiment, the food is heated, washed, cooled, frozen, irradiated, dried, vacuumed or aerated during the preservation step. For example, the food can be preserved in that it is cooked, i.e. is converted into a consumable state by supplying energy.

The food product can be, for example, deep fried, baked or hot air dried. However, other cooking techniques such as frying or humid cooking techniques such as boiling, steaming are also possible. Freeze-drying as a form of preservation is also possible.

According to one embodiment in which a precursor of the additive is introduced into the food product, the preservative selected, for example, a temperature change, irradiation with particle or electromagnetic radiation, a pressure change, or also a change in the pH-value or gas exposure, converts the precursor to the additive.

According to one embodiment, the food product is produced from a raw material, preferably raw vegetable material, such as potatoes, tubers, roots, vegetables or fruits. In particular, the raw material can be conditioned and the additive can be introduced into the raw material.

According to one further embodiment, a snack product can be produced with the method according to the invention, for example, a nibble product, such as a salty snack, or also, for example, preserved dried fruits or a salty snack such as chips or flips.

In the following, the invention shall be described by way of example in detail using advantageous embodiments with reference to the drawings and subsequent trial examples. The advantageous further developments and configurations illustrated there are each independent of each other and can be combined with one another, depending on the requirement of the application, where

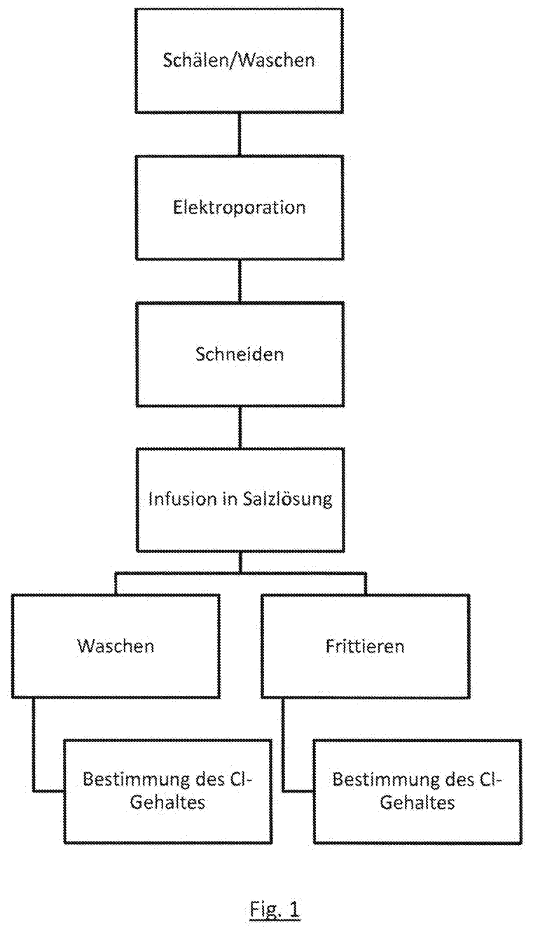

FIG. 1 shows a flow diagram of an experimental set up for an exemplary method according to one embodiment of the present invention;

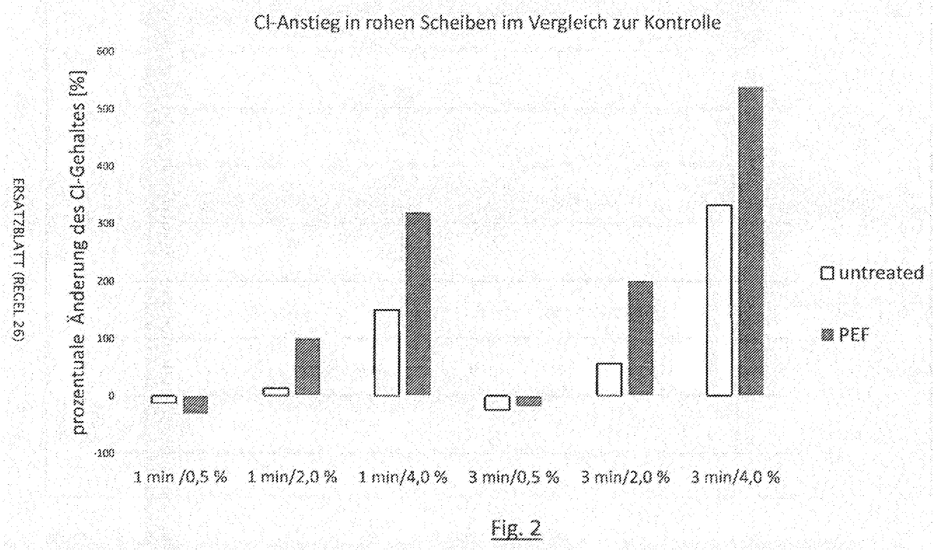

FIG. 2 shows a bar diagram showing an increase in the salt concentration of conditioned and unconditioned potato slices in comparison to a control sample;

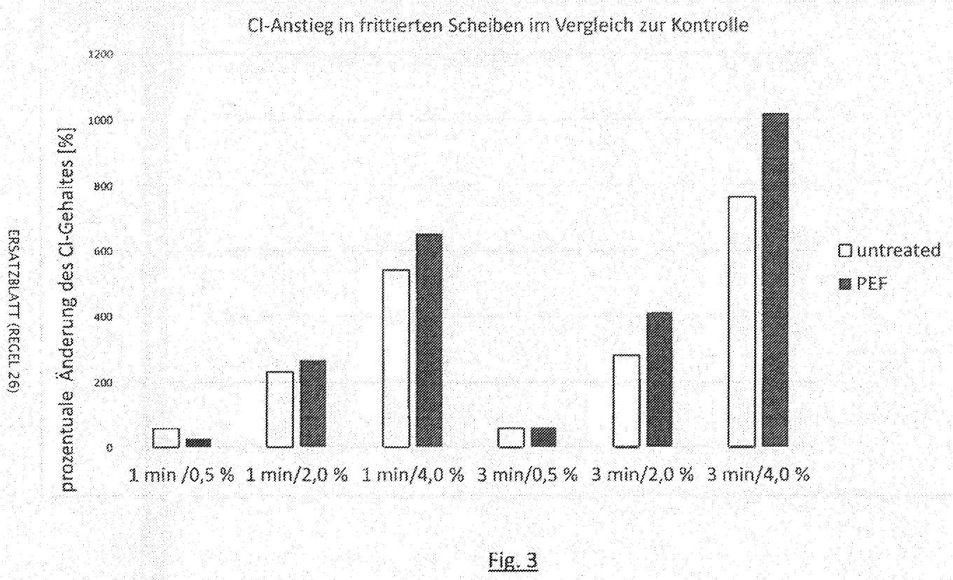

FIG. 3 shows a bar diagram showing an increase in the salt concentration of deep-fried conditioned and unconditioned potato slices in comparison to a control sample; and

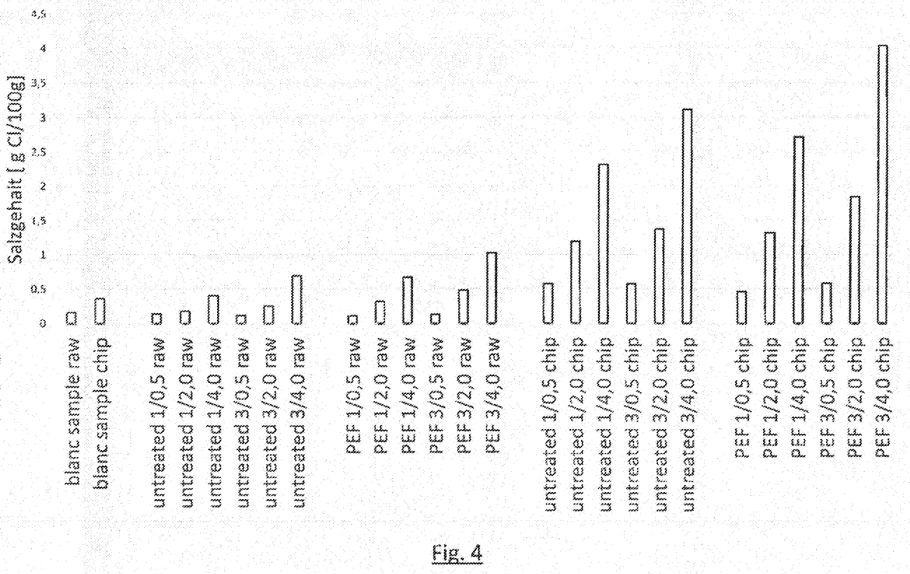

FIG. 4 shows a bar chart showing the salt contents of the control samples, the unconditioned samples as well as the conditioned samples.

Hereafter, an exemplary method for producing food products according to the present invention shall be presented with reference to the flow diagram in FIG. 1. The flow diagram of FIG. 1 outlines the sequence of the trial, which shall then be explained in more detail.

The method for producing food, in particular snack products, comprises the steps of conditioning food; introducing an additive into the food product; and preserving the food product after the additive has been introduced.

In the present flow diagram, the step of conditioning is executed by way of electroporation. The food product is there exposed to pulsed electric fields which cause cell disruption, in which the semipermeability of the cell membrane is removed. In the flow diagram of FIG. 1, the step of conditioning is preceded by a step of peeling and washing the food product.

Following the electroporation, the food product in the exemplary method according to the flow diagram of FIG. 1 is reduced in size, namely cut. With mechanical energy acting upon the food product, the surface area effectively available for substance transport is enlarged in the exemplary method, which improves the diffusion of additives into the food product in the subsequent step of introducing the additive into the food product. In the exemplary method, the additive is introduced into the food product by placing the food product in a salt solution. An infusion of salt therefore takes place.

After the step of introducing the additive, salt in this example, into the food product, a step of preserving the food product takes place. Two preservation methods shall be examined in the exemplary flow diagram. Firstly, the food is cooked, namely deep-fried. As an alternative preservation method, the food is washed before the salt content in the food product produced is determined by determining the concentration of chloride ions.

Exemplary embodiments of the method according to the invention shown in flow diagram 1 shall be described below in more detail on the basis of some concrete trial results.

Trial: Influence of Conditioning, by Applying an Electric Field, Upon the Introduction of an Additive into a Food Product.

The trial was conducted in the sequence as shown in the flow diagram of FIG. 1.

Potatoes of the Lady Claire variety, which were peeled and washed in a first step, were examined.

The samples were subsequently exposed to pulsed electric fields. Electroporation took place under the following conditions:

W=0.63 kJ/kg

E=1.07 kV/cm

Number of pulses (n)=7

Pulse duration=7-50 micro-seconds

The samples were then cut into potato slices about 1.4 mm wide before being placed into a salt bath while gently stirring for one and three minutes, respectively. The salt (sodium chloride) concentration in the salt bath was
0% for the control samples;
0.5%, 2% and 4% respectively for the unconditioned (without electroporation) and conditioned (with electroporation) samples.

The dwell time in the salt bath was 0 minutes for the control samples and one and three minutes for the unconditioned and conditioned samples, respectively.

After introducing the additive by placement into the salt solution, a sample group was preserved by washing it in tap water for 10 seconds (“raw”), The other sample was deep-fried for three minutes at 170° C. (“chip”).

Finally, the salt content of the food product was determined by mass spectrometrically determining the sodium content in the individual samples using ICP (induced coupled plasma).

The salt concentrations of the samples determined are summarized in the example diagram of FIG. 4. In FIG. 4:
‘blank sample’ means a control sample of a potato which has only been peeled, washed and sliced, i.e. not exposed to electroporation or placed into a salt bath;
‘untreated 1’ means an unconditioned sample which has not undergone electroporation and which has been placed in the salt bath for one minute;
‘untreated 3’ means an unconditioned sample which has not undergone electroporation and which has been placed in the salt bath for three minutes;
‘PEF 1’ means a conditioned sample which has undergone electroporation and has been treated for one minute in the salt bath;
‘PEF 3’ means a conditioned sample which has undergone electroporation and has been treated for three minutes in the salt bath;
‘raw’ means a sample that was washed before the salt content was determined;
‘chip’ means a sample that was deep-fried before the salt content was determined;
the numbers “0.5”, “2.0” or “4.0”: preceding “chip” or “raw” indicate the salt concentration, 0.5%, 2% or 4% of the after-solution into which the food product was placed.

As can be seen in FIG. 4, the step of conditioning significantly increased the salt content of the samples, both in comparison with the control samples as well as in comparison with the unconditioned samples, which were treated identically to the conditioned samples, except for the electroporation.

This result is also reflected in the bar diagrams of FIGS. 2 and 3 in which the unconditioned and conditioned samples were compared. It turns out that significantly more salt is introduced into the samples with the method according to the invention, in particular at the higher concentrations of 2 and 4% salt in the salt bath.

Similar trials like the trial presented with potato slices were also conducted with beetroot and sweet potatoes. In trials with beetroot, the slice was placed for one minute in a 2.5% salt solution, with sweet potatoes in a 5% salt solution.

An improvement in the color and crispiness in the final product and an increased salt intake could be noted also for beetroot and sweet potato, like with potatoes, when using the method according to the invention.

1. Method for the production of a food product comprising the steps of:
conditioning said food product by applying an electric field;
introducing an additive into said food product; and
preserving said food product after said additive has been introduced.

2. Method according to claim 1, characterized in that a pulsed electric field causing cell disruption is applied during the conditioning.

3. Method according to claim 1, characterized in that the step of conditioning takes place before or during the step of introducing the additive.

4. Method according to claim 1, characterized by the further step of mechanical energy acting upon said food product during or after the step of introducing the additive.

5. Method according to claim 4, characterized in that mechanical energy acts in that said food product is cut up, stirred, kneaded, beaten and/or tossed.

6. Method according to claim 1, characterized in that an additive providing flavor, providing structure, providing coloring, providing aroma, regulating the utilization value, regulating the nutritional value, stabilizing the utilization value, stabilizing the nutritional value and/or an additive ensuring trouble-free further processing, or a precursor convertible into such an additive is introduced into said food product.

7. Method according to claim 6, characterized in that a precursor which is converted into the additive during the preservation is introduced into said food product.

8. Method according to claim 1, characterized in that the additive is brought into contact with said food product as a dry product, dissolved or as an emulsion and is thus introduced into said food product.

9. Method according to claim 8, characterized in that the additive is injected into said food product, said food product is placed into the additive, said food product is brushed with the additive, said food product is dusted with the additive and/or said food product is sprayed with the additive.

10. Method according to claim 1, characterized by the further step of adjusting a desired oil content of said food product, preferably prior to the step of preservation.

11. Method according to claim 10, characterized in that the oil content is adjusted when the additive is introduced into said food product.

12. Method according to claim 1, characterized in that said food product is heated, cooled, frozen, irradiated, dried, vacuumed and/or aerated during the step of preservation.

13. Method according to claim 12, characterized in that said food product is cooked.

14. Method according to claim 1, characterized in that said food product is produced from raw vegetable material.

15. Method according to claim 1, characterized in that said food product produced is a snack product, preferably a nibble product and particularly preferably a salty snack.

16. Method according to claim 2, characterized in that the step of conditioning takes place before or during the step of introducing the additive.

17. Method according to claim 2, characterized by the further step of mechanical energy acting upon said food product during or after the step of introducing the additive.

18. Method according to claim 3, characterized by the further step of mechanical energy acting upon said food product during or after the step of introducing the additive.

19. Method according to claim 2, characterized in that an additive providing flavor, providing structure, providing coloring, providing aroma, regulating the utilization value, regulating the nutritional value, stabilizing the utilization value, stabilizing the nutritional value and/or an additive ensuring trouble-free further processing, or a precursor convertible into such an additive is introduced into said food product.

20. Method according to claim 3, characterized in that an additive providing flavor, providing structure, providing coloring, providing aroma, regulating the utilization value, regulating the nutritional value, stabilizing the utilization value, stabilizing the nutritional value and/or an additive ensuring trouble-free further processing, or a precursor convertible into such an additive is introduced into said food product.
